(19) United States
(12) Patent Application Publication
(10) Pub. No.: US 2016/0285081 A1
(43) Pub. Date: Sep. 29, 2016

(54) NEGATIVE ELECTRODE FOR NONAQUEOUS ELECTROLYTE SECONDARY BATTERY AND NONAQUEOUS ELECTROLYTE SECONDARY BATTERY INCLUDING THE SAME

(71) Applicant: Kabushiki Kaisha Toshiba, Minato-ku (JP)

(72) Inventors: Shinsuke MATSUNO, Minato (JP); Norikazu OSADA, Meguro (JP); Sara YOSHIO, Taito (JP); Takashi KUBOKI, Ota (JP)

(73) Assignee: Kabushiki Kaisha Toshiba, Minato-ku (JP)

(21) Appl. No.: 15/075,653

(22) Filed: Mar. 21, 2016

(30) Foreign Application Priority Data
Mar. 23, 2015 (JP) 2015-059519

(51) Int. Cl. H01M 4/36; H01M 4/133; H01M 4/587; H01M 4/38; H01M 4/131; H01M 4/48; H01M 10/0525; H01M 4/134

(52) U.S. Cl. CPC H01M 4/364; H01M 10/0525; H01M 4/133; H01M 4/134; H01M 4/386; H01M 4/131; H01M 4/483; H01M 4/587; H01M 2004/027

(57) ABSTRACT

A negative electrode for a nonaqueous electrolyte secondary battery of the embodiment includes: a negative electrode current collector; and a negative electrode active material layer which includes a negative electrode active material and is formed on the negative electrode current collector. The negative electrode active material layer includes silicon capable of reacting with lithium. The negative electrode active material layer includes a 1st layer containing an oxidized silicon compound and a 2nd layer containing the oxidized silicon compound. The 2nd layer has the smaller amount of the oxidized silicon compound than the 1st layer. The 2nd layer is provided on the surface of the negative electrode current collector.

### CROSS-REFERENCE TO RELATED APPLICATION

This application is based upon and claims the benefit of priority from Japanese Patent Application No. 2015-059519, filed Mar. 23, 2015, the entire contents of which are incorporated herein by reference.

### FIELD

Embodiments described herein relate generally to a negative electrode for a nonaqueous electrolyte secondary battery and a nonaqueous electrolyte secondary battery including the same.

### BACKGROUND

A nonaqueous electrolyte secondary battery (mainly lithium ion secondary battery), which is made by using a layered oxide containing a carbon material as a negative electrode active material and using nickel, cobalt or manganese as a positive electrode active material, has been already practically used as an electric power source in a wide range of fields from a small product such as various types of an electronic equipment to a large product such as electric vehicles For a nonaqueous electrolyte secondary battery, further miniaturization, weight reduction, long-term use and long life has been strongly required by users.

In recent years, in addition to a positive electrode and a negative electrode, various materials of a nonaqueous electrolyte secondary battery have been actively developed. It has been proposed to use silicon (Si) as a negative electrode material which can achieve the higher battery capacity than a carbonaceous material. Although Si element can achieves the about 10 times larger negative electrode capacity than a carbon material, volumetric expansion and contraction is large during charge and discharge, and it is difficult to achieve long life. Therefore, the technique has been proposed which complexes Si and a carbon material so as to achieve both high battery capacity and long life.

Meanwhile, a negative electrode material made by complexing Si and a carbon material has the problem in battery safety. In other words, there have been the problems in that a large amount of heat is generated by the reaction with an electrolyte during charge and that a large current tends to flow immediately in a forced short-circuit condition such as nail penetration in a fully charged condition, which causes ignition.

The present inventors have investigated and confirmed that the safety in a forced short-circuit condition is improved by complexing a carbon material and a Si oxide capable of being charged and discharged. It can be considered that the reaction of a negative electrode material and an electrolyte is suppressed by the existence of a Si oxide. Also, it can be considered that a negative electrode itself is almost insulated by the existence of a Si oxide during short-circuit discharge in a nonaqueous electrolyte secondary battery, and a continued short-circuit current hardly flows, and consequently, overheat does not occur. As described above, when a Si oxide and a carbon material arc contained in a negative electrode material, the tendency of improving the safety of a nonaqueous electrolyte secondary battery can be confirmed, but an irreversible reaction is likely to occur during initial charge, and therefore, there has been the problem that it is difficult to achieve high battery capacity of a whole battery.

### BRIEF DESCRIPTION OF DRAWINGS

FIG. 1 is a conceptual sectional view illustrating the negative electrode according to the 1st embodiment.

FIG. 2 is a schematic view illustrating the nonaqueous electrolyte secondary battery according to the 2nd embodiment.

FIG. 3 is a schematic view illustrating the nonaqueous electrolyte secondary battery according to the 2nd embodiment.

FIG. 4 is a schematic view illustrating the nonaqueous electrolyte secondary battery according to the 2nd embodiment.

FIG. 5 is a schematic view illustrating the nonaqueous electrolyte secondary battery according to the 2nd embodiment.

FIG. 6 is a schematic perspective view illustrating the battery pack according to the 3rd embodiment.

FIG. 7 is a schematic view illustrating the battery pack according to the 3rd embodiment.

FIG. 8 is the graph showing the result of the X-ray absorption spectroscopy measurement carried out for the nonaqueous electrolyte secondary battery of Example 1.

### DETAILED DESCRIPTION

Hereinafter, the negative electrode for a nonaqueous electrolyte secondary battery of the embodiment and the nonaqueous electrolyte secondary battery including this negative electrode are described with reference to the drawings.

The negative electrode for a nonaqueous electrolyte secondary battery of the embodiment includes: a negative electrode current collector; and a negative electrode active material layer which includes a negative electrode active material and is formed on the negative electrode current collector. The negative electrode active material layer includes silicon capable of reacting with lithium. The negative electrode active material layer includes a 1st layer containing an oxidized silicon compound and a 2nd layer containing the oxidized silicon compound. The 2nd layer has the smaller amount of the oxidized silicon compound than the 1st layer. The 2nd layer is provided on the surface of the negative electrode current collector.

### First Embodiment

The 1st embodiment provides the negative electrode for a nonaqueous electrolyte secondary battery including a negative electrode current collector; and a negative electrode active material layer which includes a negative electrode active material and is formed on the negative electrode current collector (hereinafter abbreviated as a “negative electrode”).

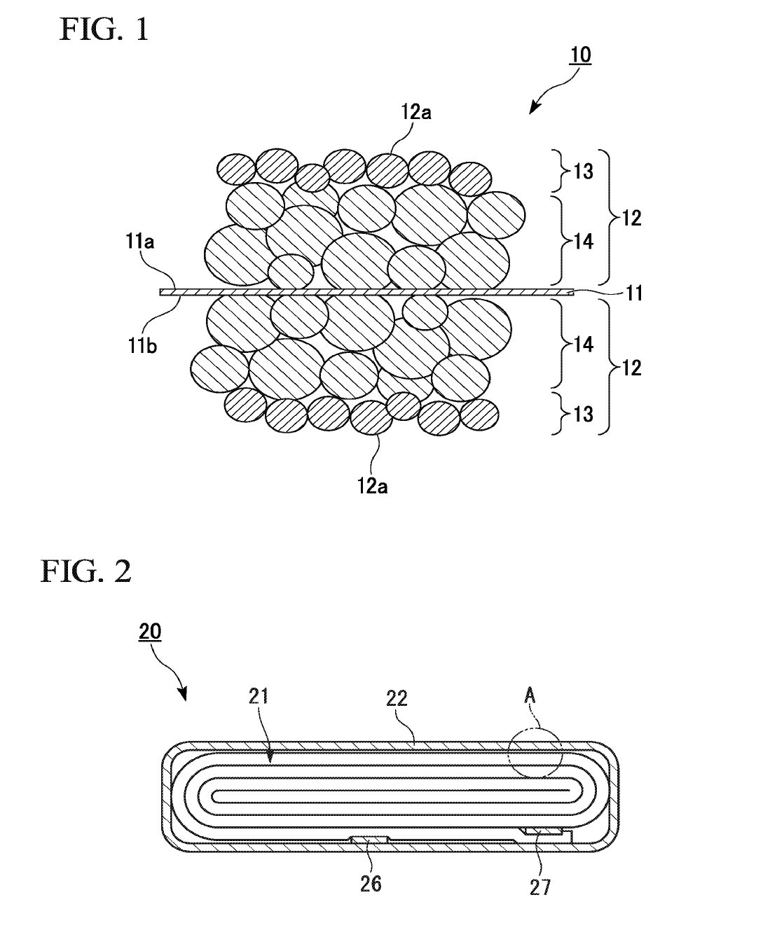

Hereinafter, the negative electrode for a nonaqueous electrolyte secondary battery according to the present embodiment is described in detail with reference to FIG. 1.

FIG. 1 is a conceptual sectional view illustrating the negative electrode for a nonaqueous electrolyte secondary battery according to the present embodiment.

The negative electrode 10 for a nonaqueous electrolyte secondary battery according to the present embodiment includes the negative electrode current collector 11; and the negative electrode active material layer 12 as shown in FIG. 1.

The negative electrode active material layer 12 is the layer which is provided on the one surface 11a and the other surface 11b of the negative electrode current collector 11 and includes silicon (Si) capable of reacting with lithium (Li), an electroconductive agent and a binder. A binder binds the negative electrode current collector 11 and the negative electrode active material layer 12. An electroconductive agent and a binder are optional components.

The negative electrode active material layer 12 is formed by laminating the 1st layer 13 containing an oxidized silicon compound and the 2nd layer 14 containing an oxidized silicon compound in the thickness direction of the negative electrode active material layer 12. Also, the 2nd layer 14 has the smaller amount of the oxidized silicon compound than the 1st layer 13. Also, the 2nd layer 14 is provided on the surface of the negative electrode current collector 11, i.e. on the one surface 11a and the other surface 11b of the negative electrode current collector 11.

Silicon capable of reacting with lithium means Si and an oxidized Si compound (hereinafter referred to as a “Si oxide”).

Examples of a Si oxide include SiOₓ(1≦x≦2). This Si oxide can be amorphous or in a state where Si and SiO₂ are disproportionated.

Herein, a Si oxide is described by exemplifying the Si oxide represented by SiO_{1.5} and SiOₓ in which x is less than 0.5 (i.e. Si which is hardly oxidized).

It is studied that a negative electrode is produced by forming a negative electrode active material layer on a negative electrode current collector by using a negative electrode material in which the Si oxides represented by Si and SiO_{1.5} are mixed in an arbitrary mixing ratio, and then a nonaqueous electrolyte secondary battery including this negative electrode is produced.

The battery capacity of a nonaqueous electrolyte secondary battery is determined by the mixing ratio of the Si oxides represented by Si and SiO_{1.5}. As the ratio of the Si oxide represented by SiO_{1.5} increases, the initial battery capacity of a nonaqueous electrolyte secondary battery decreases. Also, when the ratio of the Si oxide represented by SiO_{1.5} is set to 85 mass %, ignition can be prevented in a nail penetration test for a fully charged nonaqueous electrolyte secondary battery. As a result of considering the mechanism of the ignition in the nail penetration test, the following was found. When simply mixing the Si oxides represented by Si and SiO_{1.5}, the insulation of a negative electrode itself hardly occur and short circuit may occur between a negative electrode and a positive electrode even though it is possible to suppress the heat generation due to a side reaction of a negative electrode and an electrolyte solution. Therefore, short circuit and discharge can be prevented from occurring by setting the ratio of the Si oxide represented by SiO_{1.5} to 85 mass %, it is possible to prevent short-circuit discharge from occurring.

In the present embodiment, the negative electrode active material layer 12 is formed such that the ratio of the Si oxide represented by SiO_{1.5} increases on the side of the surface 12a of the negative electrode active material layer 12 and the ratio of Si increases on the sides of one side 11a and the other side 11b of the negative electrode current collector 11. Consequently, as described above, as the ratio of the Si oxide represented by SiO_{1.5} increases, the initial battery capacity of the nonaqueous electrolyte secondary battery including the negative electrode 10 decreases in the same manner as the case where the Si oxides represented by Si and SiO_{1.5} are simply mixed. However, ignition does not occur in the nail penetration test for the fully charged nonaqueous electrolyte secondary battery by increasing the ratio of the Si oxide represented by SiO_{1.5} on the side of the surface 12a of the negative electrode active material layer 12 and increasing the ratio of Si on the sides of one side 11a and the other side 11b of the negative electrode current collector 11 even though the ratio of the Si oxide represented by SiO_{1.5} is 10 mass % in the whole negative electrode active material layer 12. The reason therefor can be considered as follows. When a lot of the Si oxides represented by SiO_{1.5} are present on the side of the surface 12a of the negative electrode active material layer 12, the surface 12a part (1st layer) of the negative electrode active material layer 12 is insulated in the forced short circuit due to nail penetration, and the direct contact between the negative electrode and the positive electrode is avoided. For this reason, continuous short-circuit discharge hardly occurs.

By the way, the publication of Japanese Patent Application No. 2005-516858 discloses a technique of applying an insulating layer such as alumina (Al₂O₃) or titania (TiO₂) on a surface layer of the negative electrode, etc. This kind of technique also can suppress the short-circuit discharge as described above, and contributes to an improvement in battery safety. However, an insulator material itself such as alumina (Al₂O₃) or titania (TiO₂) is difficult to absorb Li, and has a very little charge and discharge capacity. Moreover, when a negative electrode is completely covered with alumina (Al₂O₃) or titania (TiO₂), Li diffusion into a negative electrode is inhibited, rate performance of a nonaqueous electrolyte secondary battery decreases.

By contrast, when the Si oxide represented by SiO_{1.5} is contained in a negative electrode, it is possible to charge and discharge a nonaqueous electrolyte secondary battery even though this Si oxide does not contribute to an increase in the battery capacity of a nonaqueous electrolyte secondary battery as compared to Si. In other words, the Si oxide represented by SiO_{1.5} hardly causes the inhibition of rate performance of a nonaqueous electrolyte secondary battery during a usual discharge.

The negative electrode active material layer 12 contains at least three elements of the silicon (Si), carbon (C) and oxygen (O). In other words, the 1st layer 13 and the 2nd layer 14 constituting the negative electrode active material layer 12 contains at least three elements of silicon (Si), carbon (C) and oxygen (O).

The ratio of the oxygen to the total amount of the three elements contained in the 1st layer 13 is preferably 15 atom % or more and 50 atom % or less, and more preferably 20 atom % or more and 45 atom % or less.

The ratio of the oxygen to the total amount of the three elements contained in the 2nd layer 14 is preferably 5 atom % or more and less than 15 atom %, and more preferably 7 atom % or more and 12 atom % or less.

The Si and O contained in the negative electrode active material layer 12 mean Si and an oxidized Si compound. Also, the C contained in the negative electrode active material layer 12 means crystalline graphite for maintaining the electroconductivity of the negative electrode active material layer 12, amorphous carbon (soft carbon or hard carbon) for complexing Si or an oxidized silicon compound, or a polymer binder component (such as PVDF, polyimide).

When the ratio of oxygen is set to 15 atom % or more in the 1st layer 13, it is possible to suppress the short-circuit discharge in the nonaqueous electrolyte secondary battery including the negative electrode 10, and to prevent the overheating and ignition of the battery. Meanwhile, when the ratio of oxygen is set to 50 atom % or less in the 1st layer 13, it is possible to prevent the increase in the irreversible battery capacity at the initial charge in the nonaqueous electrolyte secondary battery including the negative electrode 10. Also, it is possible to increase the battery capacity of the battery, and the lithium diffusion is facilitated on the surface of the negative electrode active material layer 12. Also, it is possible to prevent the deterioration of the large current characteristics such as the rate performance of the nonaqueous electrolyte secondary battery.

When the ratio of oxygen is set to 5 atom % or more in the 2nd layer 14, the adhesion increases between the negative electrode current collector 11 and the negative electrode active material layer 12, and the separation of the negative electrode active material layer 12 is unlikely to occur during charge and discharge. Also, it is possible to prevent the separation of the negative electrode active material from the negative electrode active material layer 12. Meanwhile, when the ratio of oxygen is set to less than 15 atom % in the 2nd layer 14, it is possible to increase the battery capacity of the battery including the negative electrode 10.

The ratio of the thickness of the 1st layer 13 to the thickness of the negative electrode active material layer 12 (full length) is preferably 5% or more and 50% or less, and more preferably 10% or more and 40% or less.

Herein, if, for example, the thickness (full length) of the negative electrode active material layer 12 is 80 μm and the thickness of the 1st layer 13 is 8 μm, the ratio of the thickness of the 1st layer 13 to the thickness (full length) of the negative electrode active material layer 12 becomes 10%.

The binder fills the gap between the dispersed Si capable of reacting Li so as to bind the Si capable of reacting Li to each other or to bind the dispersed Si capable of reacting Li and the electroconductive agent. Also, the binder binds the negative electrode current collector 11 and the dispersed Si capable of reacting Li or the electroconductive agent.

Examples of the binder include polytetrafluoroethylene (PTFE), polyvinylidene fluoride (PVdF), fluorine-based rubber, styrene-butadiene rubber (SBR), polypropylene (PP), polyethylene (PE), carboxymethyl cellulose (CMC), polyimide (PI), and polyacrylimide (PAI). Of these, a polymer such as polyimide having an imide structure is more preferable because the bonding force to the negative electrode current collector 11 is high and it is possible to increase the binding force between the negative electrode materials.

The binder can be used alone or in combination of two or more. When the binder is used in combination of two or more, the life property of the negative electrode 10 can be improved by employing the combination of the binder having excellent binding property for the negative electrode materials and the binder having excellent binding property for the negative electrode material and the negative electrode current collector 11, or the combination of the binder having high hardness and the binder having excellent flexibility.

As the conductive agent, a carbon material is used usually. As a carbon material, a material, in which the both characteristics of electroconductivity and absorbing property of an alkali metal are excellent, is used. Examples of a carbon material include acetylene black, carbon black, graphite having high crystallinity.

Regarding the blending ratio of the Si capable of reacting with Li, the electroconductive agent and the binder in the negative electrode active material layer 12, the Si capable of reacting with Li is preferably blended within a range of 70 mass % or more and 95 mass % or less, the electroconductive agent is preferably blended within a range of 0 mass % or more and 25 mass % or less, and the binder is preferably blended within a range of 2 mass % or more and 10 mass % or less. Finally, the total of the silicon element and the tin element contained in the negative electrode active material layer 12 is preferably within a range of 5% or more and 80% or less in an atomic ratio to the carbon element.

The negative electrode current collector 11 is the electroconductive member that binds the negative electrode active material layer 12. As the negative electrode current collector 11, it is possible to use an electroconductive substrate having a porous structure or a non-porous electroconductive substrate. These electroconductive substrates can be formed of an electroconductive material such as copper, nickel, alloys thereof or stainless steel. Of these electroconductive materials, copper (including a copper alloy) or stainless steel is the most preferable in terms of electroconductivity.

Next, the production method of the negative electrode 10 is described.

Firstly, the Si capable of reacting with Li, the Si oxide and the binder are suspended in a general solvent so as to prepare a slurry. Herein, the electroconductive agent is added thereto as necessary so as to prepare a slurry.

In this preparation of the slurry, the 1st slurry containing the Si oxide and the 2nd slurry containing the Si oxide, in which an amount of the Si oxide is smaller than that in the 1st slurry, are prepared.

Subsequently, the 2nd slurry is applied onto the one surface 11a and the other surface 11b of the negative electrode current collector 11 followed by drying to form the 2nd layer 14 having the smaller amount of the Si oxide than the 1st layer 13.

Subsequently, the 1st slurry is applied on the 2nd layer 14 followed by drying to form the 1st layer 13 having the larger amount of the Si oxide than the 2nd layer 14 on the 2nd layer 14.

Then, the laminated body of the 1st layer 13 and the 2nd layer 14 formed on the negative electrode current collector 11 is subjected to pressing, to thereby obtain the negative electrode 10.

According to the negative electrode 10 for a nonaqueous electrolyte secondary battery of the present embodiment, the negative electrode active material layer 12 is formed by laminating the 1st layer 13 containing the oxidized silicon compound and the 2nd layer 14 containing the oxidized silicon compound in the thickness direction of the negative electrode active material layer 12. Also, the 2nd layer 14 has the smaller amount of the oxidized silicon compound than the 1st layer 13. Also, the 2nd layer 14 is provided on the surface of the negative electrode current collector 11. For these reasons, it is possible to achieve the high battery capacity of the nonaqueous electrolyte secondary battery which includes the negative electrode 10 for a nonaqueous electrolyte secondary battery. Also, it is possible to improve the safety in the nonaqueous electrolyte secondary battery.

The present embodiment shows the case where the negative electrode active material layer 12 is formed on the one surface 11a and the other surface 11b of the negative electrode current collector 11, but the negative electrode 10 of the present embodiment is not limited thereto. In the negative electrode 10, the negative electrode active material layer 12 may be formed on at least one of the one surface 11a and the other surface 11b of the negative electrode current collector 11.

### Second Embodiment

The 2nd embodiment provides the nonaqueous electrolyte secondary battery including the negative electrode according to the aforementioned 1st embodiment, a positive electrode, a nonaqueous electrolyte, a separator and an exterior material.

More specifically, the nonaqueous electrolyte secondary battery according to the present embodiment includes an exterior material, a positive electrode that is housed in the external material, the negative electrode that is spatially separated from the positive electrode and is housed in the external material with a separator interposed therebetween, and a nonaqueous electrolyte charged in the external material.

In the nonaqueous electrolyte secondary battery according to the present embodiment, it is preferable that at least two absorption peaks at a Si K-edge in X-ray absorption spectroscopy (XAS) during 1 V discharge be present within a range from 1835 eV to 1850 eV.

When the nonaqueous electrolyte secondary battery according to the present embodiment is disassembled in a state of being discharged to 1 V and the Si K-edge of the negative electrode in X-ray absorption spectroscopy is observed, it is possible to confirm the existence of the plurality of Si compounds. At least the absorption peak (absorption edge) in the vicinity of 1840 eV and the absorption peak (absorption edge) within a range from 1840 eV to 1850 eV are present within a range from 1835 eV to 1850 eV. The absorption peak (absorption edge) in the vicinity of 1840 eV is attributed to Si, and the absorption peak (absorption edge) within a range from 1840 eV to 1850 eV is attributed to the Si oxide.

The Si oxide contained in the negative electrode according to the 1st embodiment described above is the particle represented by SiOₓ (1≦x≦2). These compounds can be amorphous or highly crystalline. In SiOx, the position of the peak appearing within a range from 1840 eV to 1850 eV changes depending on the value of x. As x is small, there is a tendency that the absorption peak appears on the low-energy side.

Hereinafter, the negative electrode, the positive electrode, the nonaqueous electrolyte, the separator and the exterior material, which are constituent members of the nonaqueous electrolyte secondary battery according to the present embodiment, are described in detail.

### (1) Negative Electrode

As the negative electrode, the aforementioned negative electrode according to the 1st embodiment is used.

### (2) Positive Electrode

The positive electrode includes the positive electrode current collector and the positive electrode mixture layer which is formed on one surface or both surfaces of the positive electrode current collector and includes a positive electrode active material, an electroconductive agent and a binder. An electroconductive agent and a binder are optional components.

Examples of the positive electrode active material include a lithium-manganese composite oxide (such as LiₓMn₂O₄ or LiₓMnO₂), a lithium-nickel composite oxide (such as LiₓNiO₂), a lithium-cobalt composite oxide (such as LiₓCoO₂), a lithium-nickel-cobalt composite oxide (such as LiNi₁₋ₓCoO₂, 0<x≦1), a lithium-manganese-cobalt composite oxide (such as LiMn₂₋ₓCoₓO₄, 0<x≦1), a lithium-copper composite oxide (such as Li₂CuₓNi₁₋ₓO₄, 0≦x≦1), and a lithium iron phosphate (such as LiMnₓFe₁₋ₓPO₄, 0≦x≦1). As the positive electrode active material, these compounds can be used alone or in combination of two or more.

The electroconductive agent improves the current collection performance of the positive electrode active material and suppresses contact resistance between the positive electrode active material and the positive current collector. Examples of the electroconductive agent include agents containing acetylene black, carbon black, artificial graphite, natural graphite, a carbon fiber, and an electroconductive polymer.

As the electroconductive agent, these types can be used alone or in combination of two or more.

The binder fills the gap between the dispersed positive electrode active materials so as to bind the positive electrode active material to the electroconductive agent and to bind the positive electrode active material to the positive electrode current collector.

Examples of the binder include polytetrafluoroethylene (PTFE), polyvinylidene fluoride (PVdF), fluorine-based rubber, styrene-butadiene rubber (SBR), polypropylene (PP), polyethylene (PE), carboxymethyl cellulose (CMC), polyimide (PI), and polyacrylimide (PAI).

As the binder, these types can be used alone or in combination of two or more.

Also, examples of an organic solvent for dispersing the binder include N-methyl-2-pyrrolidone (NMP) and dimethylformamide (DMF).

Regarding the blending ratio of the positive electrode active material, the electroconductive agent and the binder in the positive electrode mixture layer, the positive electrode active material is preferably blended within a range of 80 mass % or more and 95 mass % or less, the electroconductive agent is preferably blended within a range of 3 mass % or more and 20 mass % or less, and the binder is preferably blended within a range of 2 mass % or more and 7 mass % or less.

The positive electrode current collector is the electroconductive member to be bound with the positive electrode mixture layer. As the positive electrode current collector, an electroconductive substrate having a porous structure or a non-porous electroconductive substrate can be used.

Next, the production method of the positive electrode is described.

Firstly, the positive electrode active material, the electroconductive agent and the binder are suspended in a general solvent so as to prepare slurry.

Subsequently, the slurry is applied on the positive electrode current collector followed by drying to form the positive electrode mixture layer. Then, the positive electrode mixture layer is subjected to pressing, to thereby obtain the positive electrode.

Also, the positive electrode can be produced by molding the positive electrode active material, the binder and the electroconductive agent to be blended according to need in a pellet shape to form the positive electrode mixture layer, and disposing this positive electrode mixture layer on the positive electrode current collector.

### (3) Nonaqueous Electrolyte

As the nonaqueous electrolyte, a nonaqueous electrolyte solution, an electrolyte-impregnated polymer electrolyte, a polymer electrolyte or an inorganic solid electrolyte are used.

A nonaqueous electrolyte solution is a liquid nonaqueous electrolyte prepared by dissolving an electrolyte in a nonaqueous solvent (an organic solvent), and is held in the gap in the electrode group.

As a nonaqueous solvent, it is preferable to use the solvent which mainly contains the mixed solvent of cyclic carbonates (hereinafter, referred to as the “1st solvent”) such as ethylene carbonate (EC), propylene carbonate (PC) and vinylene carbonate, and nonaqueous solvents having lower viscosity than the cyclic carbonates (hereinafter, referred to as the “2nd solvent”).

Examples of the 2nd solvent include chain carbonates such as dimethyl carbonate (DMC), diethyl carbonate (DEC) and methylethyl carbonate (MEC); cyclic ethers such as tetrahydrofuran and 2-methyltetrahydrofuran; chain ethers such as dimethoxyethane and diethoxyethane; ethyl propionate; methyl propionate; γ-butyrolactone (GBL); acetonitrile (AN); ethyl acetate (EA); toluene; xylene; and methyl acetate (MA).

Examples of an electrolyte contained in a nonaqueous electrolyte include lithium salts such as lithium perchlorate (LiClO₄), lithium hexafluorophosphate (LiPF₆), lithium tetrafluoroborate (LiBF₄), lithium hexafluoroarsenate (LiAsF₆), and lithium trifluoromethanesulfonate (LiCF₃SO₃). Among these, it is preferable to use lithium hexafluorophosphate or lithium tetrafluoroborate.

It is preferable that the dissolving amount of the electrolyte relative to the nonaqueous solvent contained in nonaqueous electrolyte be 0.5 mol/L or more and 2.0 mol/L or less.

### (4) Separator

The separator is placed between the positive electrode and the negative electrode in order to prevent the positive electrode and the negative electrode from having contact with each other. The separator is comprised of an insulating material.

The shape, by which an electrolyte can move between the positive electrode and the negative electrode, is used for the separator. The separator is formed of a porous film such as polyethylene (PE), polypropylene (PP), cellulose or polyvinylidene fluoride (PVdF), or a nonwoven fabric made of a synthetic resin, for example.

### (5) Exterior Material

As the exterior material which houses the positive electrode, the negative electrode and the nonaqueous electrolyte, a metal container or an exterior container made of a laminated film is used.

As a metal container, the metal can, which is formed of aluminum, an aluminum alloy, iron or stainless steel in a rectangular or cylindrical shape, is used.

As an aluminum alloy, an alloy containing an element such as magnesium, zinc or silicon is preferred. When a transition metal such as iron, copper, nickel or chromium is contained in the aluminum alloy, the content of the transition metal is preferably 100 ppm or less. Because the metal container made of the aluminum alloy has the much greater strength than the metal container made of aluminum, the thickness of the metal container can be reduced. As a result, it is possible to realize the thin and lightweight nonaqueous electrolyte secondary battery which has high power and excellent heat radiation property.

Examples of a laminated film include a multi-layer film in which an aluminum foil is coated with a resin film. Usable examples of a resin constituting a resin film include a polymer compound such as polypropylene (PP), polyethylene (PE), nylon or polyethylene terephthalate (PET).

Herein, the present embodiment can be applied to the nonaqueous electrolyte battery having various shapes such as a flat type (thin type), a square type, a cylindrical type, a coin type and a button type.

Also, the nonaqueous electrolyte secondary battery according to the present embodiment can further include a lead which is electrically connected to the electrode group containing the positive electrode and the negative electrode. For example, the nonaqueous electrolyte secondary battery according to the present embodiment can include two leads. In this case, one of the leads is electrically connected to the positive electrode current collector tab and the other lead is electrically connected to the negative electrode current collector tab.

The material of the lead is not particularly limited, but for example, the same material for the positive electrode current collector and the negative electrode current collector is used.

The nonaqueous electrolyte secondary battery according to the present embodiment can further include a terminal which is electrically connected to the aforementioned lead and is drawn from the aforementioned exterior material. For example, the nonaqueous electrolyte secondary battery according to the present embodiment can include two terminals. In this case, one of the terminals is connected to the lead which is electrically connected to the positive electrode current collector tab and the other terminal is connected to the lead which is electrically connected to the negative electrode current collector tab.

The material of the terminal is not particularly limited, but for example, the same material for the positive electrode current collector and the negative electrode current collector is used.

### (6) Nonaqueous Electrolyte Secondary Battery

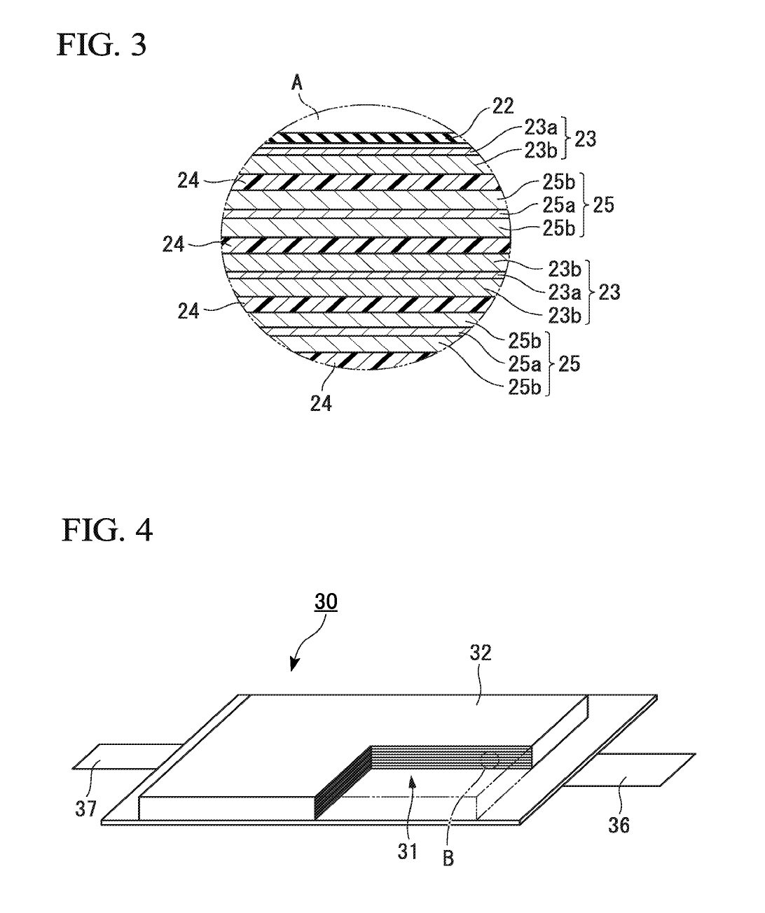

Next, the flat type nonaqueous electrolyte secondary battery (nonaqueous electrolyte secondary battery) 20 illustrated in FIG. 2 and FIG. 3 is described as an example of the nonaqueous electrolyte secondary battery according to the present embodiment. FIG. 2 is a schematic sectional view illustrating the cross-section of the flat type nonaqueous electrolyte secondary battery 20. Also, FIG. 3 is an enlarged sectional view illustrating the part A illustrated in FIG. 2. These drawings are schematic diagrams for describing the nonaqueous electrolyte secondary battery according to the embodiment. The shapes, dimensions, ratios, and the like are different from those of actual device at some parts, but design of the shape, dimensions, ratios, and the like can be appropriately modified in consideration of the following description and known technologies.

The flat type nonaqueous electrolyte secondary battery 20 illustrated in FIG. 2 is configured such that the winding electrode group 21 with a flat shape is housed in the exterior material 22. The exterior material 22 may be a container obtained by forming a laminated film in a bag-like shape or may be a metal container. Also, the winding electrode group 21 with the flat shape is formed by spirally winding the laminated product obtained by laminating the negative electrode 23, the separator 24, the positive electrode 25 and the separator 24 from the outside, i.e. the side of the exterior material 22, in this order, followed by performing press-molding. As illustrated in FIG. 3, the negative electrode 23 located at the outermost periphery has the configuration in which the negative electrode layer 23b is formed on one surface of the negative electrode current collector 23a on the inner surface side. The negative electrodes 23 at the parts other than the outermost periphery have the configuration in which the negative electrode layers 23b are formed on both surfaces of the negative current collector 23a. Also, the positive electrode 25 has the configuration in which the positive electrode layers 25b are formed on both surfaces of the positive current collector 25a. Herein, a gel-like nonaqueous electrolyte can be used instead of the separator 24.

In the vicinity of the outer peripheral end of the winding electrode group 21 illustrated in FIG. 2, the negative electrode terminal 26 is electrically connected to the negative current collector 23a of the negative electrode 23 of the outermost periphery. The positive electrode terminal 27 is electrically connected to the positive current collector 25a of the inner positive electrode 25. The negative electrode terminal 26 and the positive electrode terminal 27 extend toward the outer portion of the exterior material 22, and are connected to the extraction electrodes included in the exterior material 22.

When manufacturing the nonaqueous electrolyte secondary battery 20 including the exterior material formed of the laminated film, the winding electrode group 21 to which the negative electrode terminal 26 and the positive electrode terminal 27 are connected is charged in the exterior material 22 having the bag-like shape with an opening, the liquid nonaqueous electrolyte is injected from the opening of the exterior material 22, and the opening of the exterior material 22 with the bag-like shape is subjected to heat-sealing in the state of sandwiching the negative electrode terminal 26 and the positive electrode terminal 27 therebetween. Through this process, the winding electrode group 21 and the liquid nonaqueous electrolyte are completely sealed.

Also, when manufacturing the nonaqueous electrolyte battery 20 having the exterior material formed of the metal container, the winding electrode group 21 to which the negative electrode terminal 26 and the positive electrode terminal 27 are connected is charged in the metal container having an opening, the liquid nonaqueous electrolyte is injected from the opening of the exterior material 22, and the opening is sealed by mounting a cover member on the metal container.

For the negative electrode terminal 26, it is possible to use the material having electric stability and electroconductivity within a range of a potential equal to or more than 0 V and equal to or lower than 3 V with respect to lithium, for example. Specific examples of this material include aluminum and an aluminum alloy containing an element such as Mg, Ti, Zn, Mn, Fe, Cu or Si. Also, it is more preferable that the negative electrode terminal 26 be formed of the same material as the negative current collector 23a in order to reduce the contact resistance with the negative current collector 23a.

For the positive electrode terminal 27, it is possible to use the material having electric stability and electroconductivity within a range of a potential equal to or more than 2 V and equal to or lower than 4.25 V with respect to lithium. Specific examples of this material include aluminum and an aluminum alloy containing an element such as Mg, Ti, Zn, Mn, Fe, Cu or Si. It is more preferable that the positive electrode terminal 27 be formed of the same material as the positive current collector 25a in order to reduce the contact resistance with the positive current collector 25a.

Hereinafter, the exterior material 22, the negative electrode 23, the positive electrode 25, the separator 24, and the nonaqueous electrolyte which are constituent members of the nonaqueous electrolyte battery 20 is described in detail.

### (1) Exterior Material

As the exterior material 22, the aforementioned exterior material is used.

### (2) Negative Electrode

As the negative electrode 23, the aforementioned negative electrode is used.

### (3) Positive Electrode

As the positive electrode 25, the aforementioned positive electrode is used.

### (4) Separator

As the separator 24, the aforementioned separator is used.

### (5) Nonaqueous Electrolyte

As the nonaqueous electrolyte, the aforementioned nonaqueous electrolyte is used.

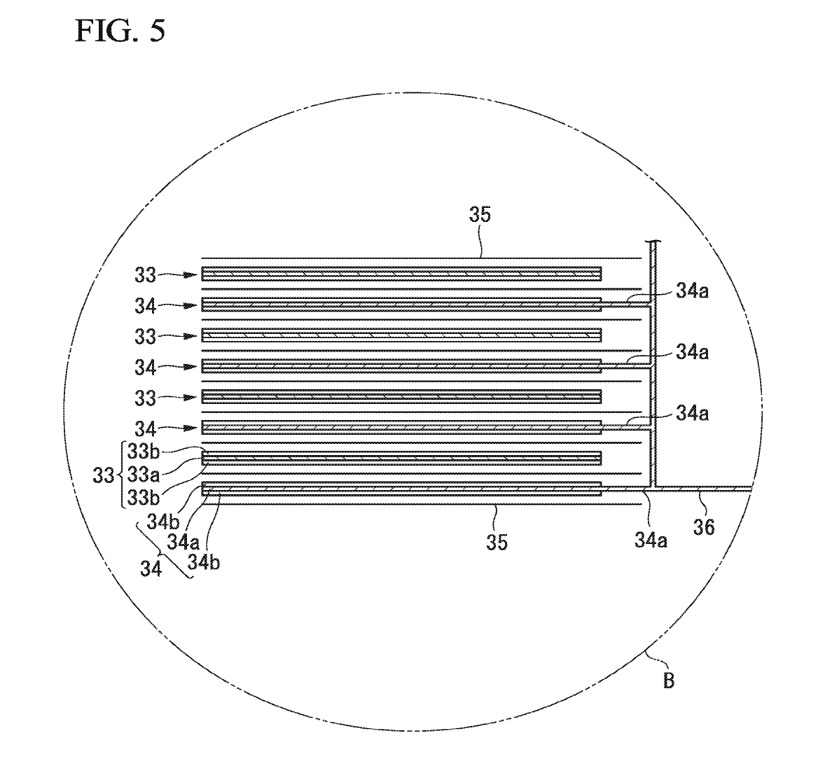

The configuration of the nonaqueous electrolyte secondary battery according to the 2nd embodiment is not limited to the aforementioned configuration illustrated in FIG. 2 and FIG. 3. For example, the batteries having the configurations illustrated in FIG. 4 and FIG. 5 can be used. FIG. 4 is a partial cutout perspective view schematically illustrating another flat type nonaqueous electrolyte secondary battery according to the 2nd embodiment. FIG. 5 is an enlarged schematic sectional view illustrating the part B of FIG. 4.

The nonaqueous electrolyte secondary battery 30 illustrated in FIG. 4 and FIG. 5 is configured such that the lamination type electrode group 31 is housed in the exterior member 32. As illustrated in FIG. 5, the lamination type electrode group 31 has the structure in which the positive electrodes 33 and negative electrodes 34 are alternately laminated while interposing separators 35 therebetween.

The plurality of positive electrodes 33 are present and each includes the positive electrode current collector 33a and the positive electrode layers 33b supported on both surfaces of the positive electrode current collector 33a. The positive electrode layer 33b contains the positive electrode active material.

The plurality of negative electrodes 34 are present and each includes the negative electrode current collector 34a and the negative electrode layers 34b supported on both surfaces of the negative electrode current collector 34a. The negative electrode layer 34b contains the negative electrode material. One side of the negative electrode current collector 34a of each negative electrode 34 protrudes from the negative electrode 34. The protruding negative electrode current collector 34a is electrically connected to a strip-shaped negative electrode terminal 36. The front end of the strip-shaped negative electrode terminal 36 is drawn from the exterior member 32 to the outside. Although not illustrated, in the positive electrode current collector 33a of the positive electrode 33, the side located opposite to the protruding side of the negative electrode current collector 34a protrudes from the positive electrode 33. The positive electrode current collector 33a protruding from the positive electrode 33 is electrically connected to the strip-shaped positive electrode terminal 37. The front end of the strip-shaped positive electrode terminal 37 is located on an opposite side to the negative electrode terminal 36, and is drawn from the side of the exterior member 32 to the outside.

The material, a mixture ratio, dimensions, and the like of each member included in the nonaqueous electrolyte secondary battery 30 illustrated in FIG. 4 and FIG. 5 are configured to be the same as those of each constituent member of the nonaqueous electrolyte secondary battery 20 described in FIG. 2 and FIG. 3.

According to the present embodiment described above, it is possible to provide the nonaqueous electrolyte secondary battery.

The nonaqueous electrolyte secondary battery according to the present embodiment includes the negative electrode, the positive electrode, the nonaqueous electrolyte, the separator and the exterior material. The negative electrode is comprised of the aforementioned negative electrode for a nonaqueous electrolyte secondary battery according to the 1st embodiment. The negative electrode active material layer constituting the negative electrode for a nonaqueous electrolyte secondary battery is formed by laminating the 1st layer having a large amount of a Si oxide and the 2nd layer having a small amount of a Si oxide in the thickness direction of the negative electrode active material layer, and the 2nd layer is provided on the surface of the negative electrode current collector. For these reasons, it is possible to achieve high battery capacity and to improve the safety in the nonaqueous electrolyte secondary battery according to the present embodiment.

### Third Embodiment

Next, the nonaqueous electrolyte secondary battery pack according to the 3rd embodiment is described in detail.

The nonaqueous electrolyte secondary battery pack according to the present embodiment includes at least one nonaqueous electrolyte secondary battery according to the aforementioned 2nd embodiment (i.e. a single battery). When the plurality of single batteries are included in the nonaqueous electrolyte secondary battery pack, the respective single batteries are disposed so as to be electrically connected in series, in parallel, or in series and parallel.

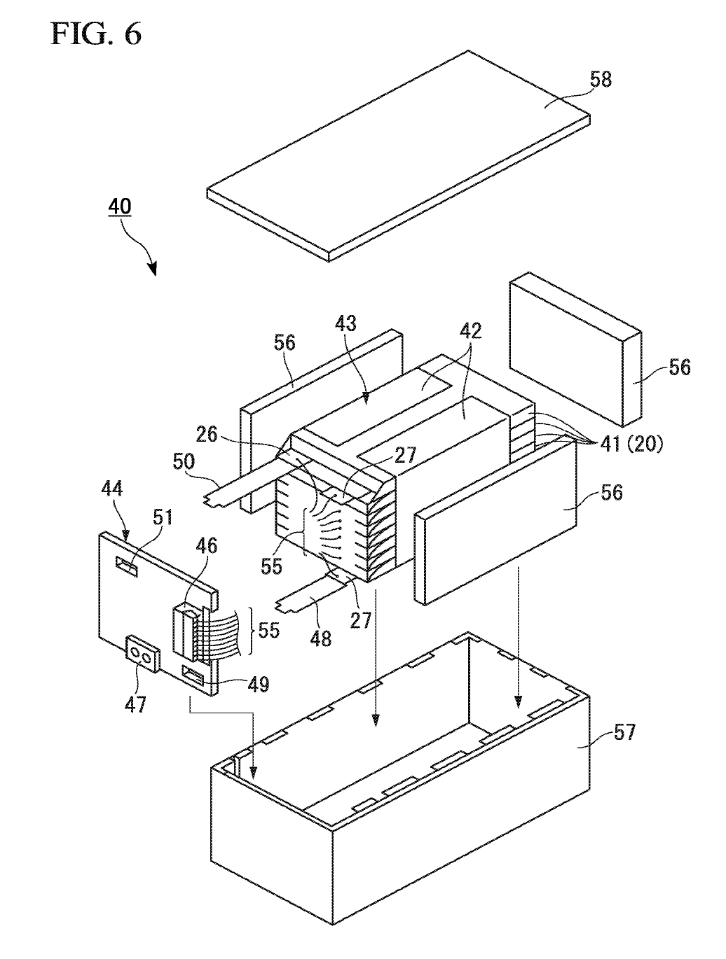

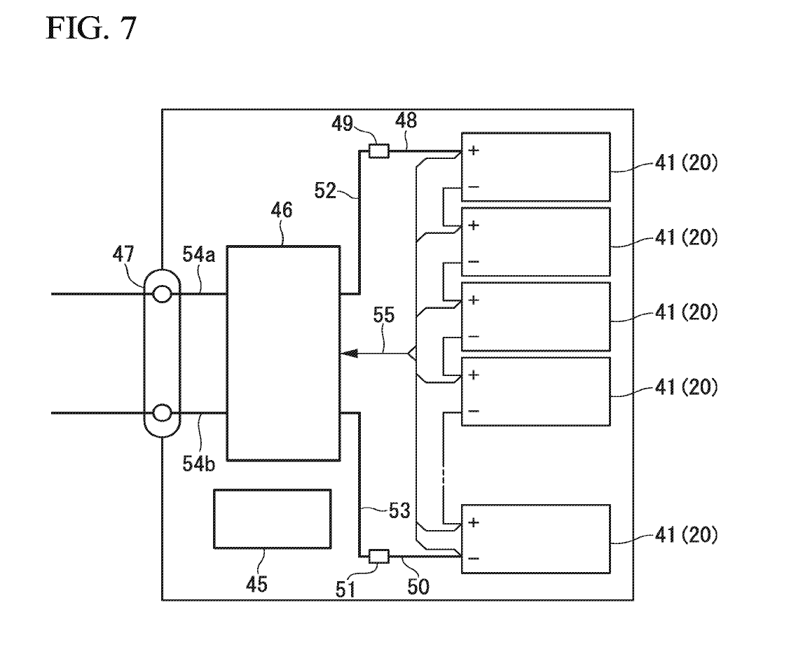

Referring to FIG. 6 and FIG. 7, the nonaqueous electrolyte secondary battery pack 40 according to the present embodiment is described in detail. In the battery pack 40 illustrated in FIG. 6, the flat type nonaqueous electrolyte battery 20 illustrated in FIG. 2 is used as the single battery 41.

The plurality of single batteries 41 are laminated so that the negative electrode terminals 26 and the positive electrode terminals 27 extending to the outside are arranged in the same direction, and thus the assembled batteries 43 are configured by fastening with the adhesive tape 42. These single batteries 41 are connected mutually and electrically in series, as illustrated in FIG. 6 and FIG. 7.

The printed wiring board 44 is disposed to face the side surfaces of the single batteries 41 in which the negative electrode terminals 26 and the positive electrode terminals 27 extend. As illustrated in FIG. 6, the thermistor 45 (see FIG. 7), the protective circuit 46 and the electrifying terminal 47 to an external device are mounted on the printed wiring board 44. Herein, an insulation plate (not illustrated) is mounted on the surface of the printed wiring board 44 facing the assembled batteries 43 in order to avoid unnecessary connection with wirings of the assembled batteries 43.

The positive electrode-side lead 48 is connected to the positive electrode terminal 27 located in the lowermost layer of the assembled batteries 43, and the front end of the positive electrode-side lead 48 is inserted into the positive electrode-side connector 49 of the printed wiring board 44 to be electrically connected. The negative electrode-side lead 50 is connected to the negative electrode terminal 26 located in the uppermost layer of the assembled batteries 43, and the front end of the negative electrode-side lead 50 is inserted into the negative electrode-side connector 51 of the printed wiring board 44 to be electrically connected. These positive electrode-side connector 49 and negative electrode-side connector 51 are connected to the protective circuit 46 via wirings 52 and 53 (sec FIG. 7) formed in the printed wiring board 44.

The thermistor 45 is used to detect a temperature of the single battery 41. Although not illustrated in FIG. 6, the thermistor 45 is installed near the single batteries 41, and a detection signal is transmitted to the protective circuit 46. The protective circuit 46 can block the plus-side wiring 54a and the minus-side wiring 54b between the protective circuit 46 and the electrifying terminal 47 for an external device under a predetermined condition. Here, for example, the predetermined condition means that the detection temperature of the thermistor 45 becomes equal to or greater than a predetermined temperature. In addition, the predetermined condition also means that an overcharge, overdischarge, overcurrent, or the like of the single battery 41 be detected. The detection of the overcharge or the like is performed for the respective single batteries 41 or all of the single batteries 41. Herein, when the overcharge or the like is detected in the respective single batteries 41, a battery voltage may be detected, or a positive electrode potential or a negative electrode potential may be detected. In the latter case, a lithium electrode used as a reference electrode is inserted into the respective single batteries 41. In the case of FIG. 6 and FIG. 7, wirings 55 for voltage detection are connected to the respective single batteries 41 and detection signals are transmitted to the protective circuit 46 via the wirings 55.

As illustrated in FIG. 6, the protective sheets 56 formed of rubber or resin are disposed on three side surfaces of the assembled batteries 43 excluding the side surface from which the positive electrode terminals 27 and the negative electrode terminals 26 protrude.

The assembled batteries 43 are stored together with the respective protective sheets 56 and the printed wiring board 44 in the storing container 57. That is, the protective sheets 56 are disposed on both of the inner surfaces of the storing container 57 in the longer side direction and the inner surface in the shorter side direction, and the printed wiring board 44 is disposed on the inner surface opposite to the protective sheet 56 in the shorter side direction. The assembled batteries 43 are located in a space surrounded by the protective sheets 56 and the printed wiring board 44. The cover 58 is mounted on the upper surface of the storing container 57.

When the assembled batteries 43 are fixed, a thermal shrinkage tape may be used instead of the adhesive tape 42. In this case, protective sheets are disposed on both side surfaces of the assembled batteries, the thermal shrinkage tape is circled, and then the thermal shrinkage tape is subjected to thermal shrinkage, so that the assembled batteries are fastened.

Here, in FIG. 6 and FIG. 7, the single batteries 41 connected in series are illustrated. However, to increase a battery capacity, the single batteries 41 may be connected in parallel or may be connected in a combination form of series connection and parallel connection. The assembled battery packs can also be connected in series or in parallel.

According to the aforementioned present embodiment, it is possible to provide the nonaqueous electrolyte secondary battery pack. The nonaqueous electrolyte secondary battery pack according to the present embodiment includes at least one of the aforementioned nonaqueous electrolyte secondary battery according to the 2nd embodiment.

This kind of nonaqueous electrolyte secondary battery pack can show a low internal resistance and high durability at a high temperature.

Herein, the form of the nonaqueous electrolyte secondary battery pack can be appropriately modified according to a use application. A use application of the nonaqueous electrolyte secondary battery pack according to the embodiment is preferably one which is required to show excellent cycle characteristics when a large current is extracted. Specifically, the battery pack can be used for power of digital cameras, a two-wheeled or four-wheeled hybrid electric vehicle, a two-wheeled or four-wheeled electric vehicle, an assist bicycle, and the like. In particular, the nonaqueous electrolyte secondary battery pack using the nonaqueous electrolyte secondary batteries with excellent high temperature characteristics is appropriately used for vehicles.

### EXAMPLES

Hereinafter, the aforementioned embodiments are described on the basis of the examples.

### Example 1

### Production of Positive Electrode

Firstly, the lithium-nickel-manganese-cobalt composite oxide (LiNi_{1/3}Mn_{1/3}Co_{1/3}O₂) powder 90 mass %, which was the active material, the acetylene black 5 mass %, and the polyvinylidene fluoride (PVdF) 5 mass % were added in the N-methylpyrrolidone, followed by mixing those to thereby prepare the slurry.

This slurry was applied on the aluminum foil having a thickness of 15 μm (the electrode current collector), dried, and then rolled to thereby form the positive electrode including the positive mixture layer having a density of 3.2 g/cm³.

### (Production of Negative Electrode)

Firstly, Si 80 mass %, the hard carbon powder 10 mass %, and polyimide (PI) 10 mass % were added in NMP, followed by mixing those to thereby prepare the slurry.

This slurry was applied on the stainless steel foil having a thickness of 10 μm (the electrode current collector), and then dried, to thereby form the Si-containing coating film.

Thereafter, SiO_{1.5} 90 mass %, the hard carbon powder 5 mass %, and PI 5 mass % were added in NMP, followed by mixing those to thereby prepare the slurry.

This slurry was overcoated on the Si-containing coating film formed on the aforementioned stainless steel foil, and then dried to thereby form the SiO_{1.5}-containing coating film.

Thereafter, the Si-containing coating film and the SiO_{1.5}-containing coating film formed on the aforementioned stainless steel foil were rolled and then heated at 500° C. for 8 hours, to thereby produce the negative electrode including the negative electrode active material layer having density of 1.6 g/cm³. In the obtained negative electrode, the 2nd layer containing Si and the 1st layer containing SiO_{1.5} were laminated in this order from the stainless steel foil side.

### (Production of Electrode Group)

The aforementioned positive electrode, the separator formed of a polyethylene porous film, the aforementioned negative electrode and the aforementioned separator were respectively laminated in this order, and then, the obtained laminated product was spirally wound such that the aforementioned negative electrode was positioned at the outermost periphery, to thereby produce the electrode group.

### (Preparation of Nonaqueous Electrolyte Solution)

Ethylene carbonate (EC) and methylethyl carbonate (MEC) were respectively mixed at the volume ratio of 1:2, to thereby prepare the mixed solvent. In this mixed solvent, lithium hexafluorophosphate (LiPF₆) was dissolved at a concentration of 1.01 mol/L, to thereby prepare the nonaqueous electrolyte solution.

### [Evaluation of Electrochemical Characteristics]

### (Production of Nonaqueous Electrolyte Secondary Battery)

The aforementioned electrode group and the aforementioned nonaqueous electrolyte solution were respectively housed in the bottomed cylindrical container formed of a stainless steel.

Subsequently, one end of the negative lead was connected with the negative electrode of the electrode group, and the other end of the negative lead was connected with the bottomed cylindrical container that also acts as the negative electrode terminal.

Subsequently, the insulating sealing plate, in the center of which the positive terminal was fitted, was prepared. One end of the positive electrode lead was connected with the positive terminal, and the other end of the positive electrode lead was connected with the positive electrode of the electrode group. Thereafter, the insulating sealing plate was swaged with the upper opening of the bottomed cylindrical container, to thereby produce the cylindrical nonaqueous electrolyte secondary battery having a capacity of 3 Ah and the aforementioned structure shown in FIG. 2.

The obtained nonaqueous electrolyte secondary battery was charged at 25° C. and a rate of 0.2 C until reaching 4.3 V and then discharged at a rate of 0.2 C until reaching 2 V, and the capacity was measured at that time. The result was referred to as the battery capacity (initial capacity) at 25° C.

After confirming the battery capacity, the nonaqueous electrolyte secondary battery was charged until reaching 4.3 V and then discharged at a rate of 3 C. The ratio of 3 C discharge capacity to the aforementioned battery capacity at a rate of 0.2 C (3 C capacity holding ratio) was calculated.

### (Observation of Negative Electrode)

The nonaqueous electrolyte secondary battery of Example 1 was discharged at a rate of 0.1 C until reaching the last 1 V. Thereafter, the battery in a discharged state was disassembled in the argon box having a dew point of −50° C., and the electrode (such as the negative electrode) was withdrawn. The withdrawn electrode was washed with methylethyl carbonate, etc., to thereby obtain the electrode which was an object to be measured.

Arbitrarily selected five parts were cut out of the negative electrode, and the cross-sectional side of the electrode was subjected to the SEM (Scanning Electron Microscope)—EDX (Energy Dispersive X-ray Spectroscopy) measurement using the magnification of 1000 times. The obtained cross-sectional image was divided into four equal parts, and two points of arbitrary points were connected in each of the obtained quarter parts. The thickness of the respective layers in the middle point of the two points was calculated using the scale bar shown in the cross-sectional image, and was referred to as the thickness of the negative electrode. As a result, the average value of the thickness of the negative electrode was 95 μm. Also, when confirming the elemental distribution regarding Si, C and O, it was possible to confirm the two layers which were the layer (the 1st layer) having the higher O ratio (oxygen ratio, the same applies hereinafter) and the layer (the 2nd layer) having the lower O ratio. The O ratio of the 1st layer was 35 atom %, and the O ratio of the 2nd layer was 8 atom %, and the layer having the lower O ratio was present on the side of the current collector.

Also, the thickness of the layer having the higher O ratio was measured at five points, and the average thickness was 12 μm. Also, the ratio of the thickness of the layer having the higher O ratio to the thickness of the negative electrode active material layer was 13%.

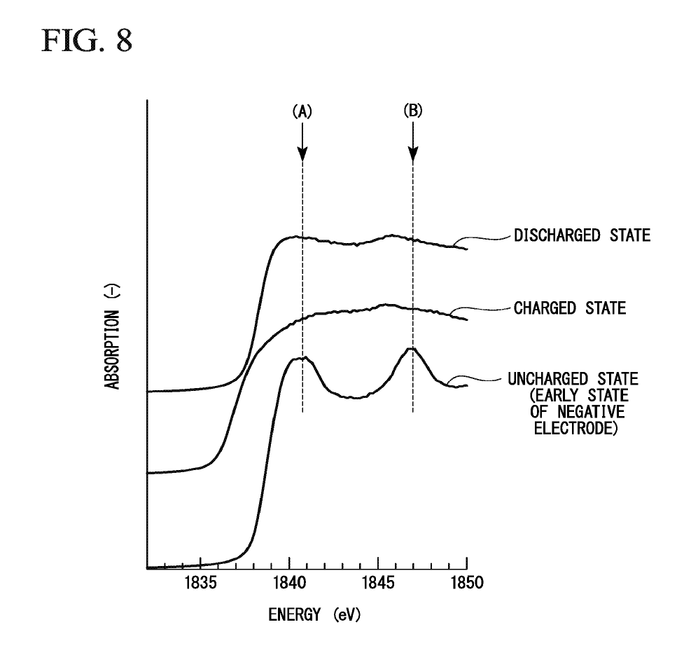

Furthermore, the nonaqueous electrolyte secondary battery of Example 1 was subjected to the XAS measurement. In the XAS measurement, the negative electrode was cut in the size of 5 mm×4 mm while maintaining an inert atmosphere. Thereafter, the sample was held in a vacuum state, and was subjected to the measurement using a fluorescence yield method. The results are shown in FIG. 8. As a reference, the measurement results in an uncharged state (an early state of a negative electrode) and the measurement results in a charged state are shown together. It could be confirmed that the peaks at the K absorption edge of Si were present in the vicinities of 1840 eV ((A) of Figure) and 1847 eV ((B) of Figure). Also, it could be confirmed that at least Si was present in the peak (A) and at least SiOₓ (1≦x≦2) was present in the peak (B). After charging, the peak (A) was shifted to the lower energy side, and the strength of the peak (B) decreased. Through these results, it was confirmed that the Si and SiO_{1.5} contained in the negative electrode active material layer respectively reacted with Li.

### (Safety Test)

The nonaqueous electrolyte secondary battery of Example 1 was subjected to the charge and discharge once at a rate of 0.2 C between 4.3V and 2.0V, and then charged at a rate of 0.2 C to 4.3V. Thereafter, the vicinity of the center portion of the nonaqueous electrolyte secondary battery was penetrated using the nail, which had a length of 120 mm, f5.0 and the conical end part of the tip with a diameter of 6 mm, at a rate of 5 mm/sec, and the behavior of the test cell (temperature increase rate) was observed. Herein, the temperature increase rate is shown by the magnification of the increased temperature with respect to room temperature by using room temperature as a standard (1).

### Example 2 to Example 11

The negative electrodes of Example 2 to Example 11 were produced in the same method as Example 1. The configuration and the values obtained in the respective measurements are shown in Table 1.

The other steps as well as the production method of the positive electrode were carried out in the same manner as Example 1, to thereby produce the nonaqueous electrolyte secondary batteries. In the same manner as in Example 1, the obtained nonaqueous electrolyte secondary batteries were subjected to the measurements for the battery capacity and the capacity holding ratio.

In the same manner as in Example 1, the negative electrodes of Example 2 to Example 11 were subjected to the SEM-EDX measurement.

In the same manner as in Example 1, the negative electrodes of Example 2 to Example 11 were subjected to the measurement for the ratio of the thickness of the layer having the higher O ratio to the thickness of the negative electrode active material layer.

In the same manner as in Example 1, the negative electrodes of Example 2 to Example 11 were subjected to the X-ray absorption spectroscopy measurement.

In the same manner as in Example 1, the negative electrodes of Example 2 to Example 11 were subjected to the safety test.

### Comparative Example 1

In the same manner as in Example 1, Si 80 mass %, the hard carbon powder 10 mass %, and polyimide (PI) 10 mass % were added in NMP, followed by mixing those to thereby prepare the slurry.

This slurry was applied on the stainless steel foil having a thickness of 10 μm (the electrode current collector), and then dried to thereby form the Si-containing coating film.

Thereafter, SiO_{1.5} was added in NMP, followed by mixing those to thereby prepare the slurry.

This slurry was overcoated on the Si-containing coating film formed on the aforementioned stainless steel foil, and then dried to thereby form the SiO_{1.5}-containing coating film.

Thereafter, the negative electrode of Comparative Example 1 was produced in the same manner as Example 1. The configuration and the values obtained in the respective measurements are shown in Table 1.

The other steps as well as the production method of the positive electrode were carried out in the same manner as Example 1, to thereby produce the nonaqueous electrolyte secondary battery. In the same manner as in Example 1, the obtained nonaqueous electrolyte secondary battery was subjected to the measurements for the battery capacity and the capacity holding ratio.

In the same manner as in Example 1, the negative electrode of Comparative Example 1 was subjected to the SEM-EDX measurement.

In the same manner as in Example 1, the negative electrode of Comparative Example 1 was subjected to the measurement for the ratio of the thickness of the layer having the higher O ratio to the thickness of the negative electrode active material layer.

In the same manner as in Example 1, the negative electrode of Comparative Example 1 was subjected to the X-ray absorption spectroscopy measurement.

In the same manner as in Example 1, the negative electrode of Comparative Example 1 was subjected to the Safety test.

### Comparative Example 2

In the same manner as in Example 1, Si 80 mass %, the hard carbon powder 10 mass %, and polyimide (PI) 10 mass % were added in NMP, followed by mixing those to thereby prepare the slurry.

This slurry was applied on the stainless steel foil having a thickness of 10 μm (the electrode current collector), and then dried to thereby form the Si-containing coating film.

Thereafter, instead of SiO_{1.5}, Al₂O₃ (alumina) having an average particle size of 13 μm 95 mass % and PI 5 mass % were added in NMP, followed by mixing those to thereby prepare the slurry.

This slurry was overcoated on the Si-containing coating film formed on the aforementioned stainless steel foil, and then dried to thereby form the Al₂O₃-containing coating film.

Thereafter, the negative electrode of Comparative Example 2 was produced in the same manner as Example 1. The configuration and the values obtained in the respective measurements are shown in Table 1.

The other steps as well as the production method of the positive electrode were carried out in the same manner as Example 1, to thereby produce the nonaqueous electrolyte secondary battery. In the same manner as in Example 1, the obtained nonaqueous electrolyte secondary battery was subjected to the measurements for the battery capacity and the capacity holding ratio.

In the same manner as in Example 1, the negative electrode of Comparative Example 2 was subjected to the SEM-EDX measurement.

In the same manner as in Example 1, the negative electrode of Comparative Example 2 was subjected to the X-ray absorption spectroscopy measurement.

In the same manner as in Example 1, the negative electrode of Comparative Example 2 was subjected to the Safety test.

### Comparative Example 3

The negative electrode was produced in the same manner as Comparative Example 2 except for using TiO₂ (titania; rutile type) having an average particle diameter of 8 μm instead of Al₂O₃. The configuration and the values obtained in the respective measurements are shown in Table 1.

The other steps as well as the production method of the positive electrode were carried out in the same manner as Example 1, to thereby produce the nonaqueous electrolyte secondary battery. In the same manner as in Example 1, the obtained nonaqueous electrolyte secondary battery was subjected to the measurements for the battery capacity and the capacity holding ratio.

In the same manner as in Example 1, the negative electrode of Comparative Example 3 was subjected to the SEM-EDX measurement.

In the same manner as in Example 1, the negative electrode of Comparative Example 3 was subjected to the measurement for the ratio of the thickness of the layer having the higher O ratio to the thickness of the negative electrode active material layer.

In the same manner as in Example 1, the negative electrode of Comparative Example 3 was subjected to the X-ray absorption spectroscopy measurement.

In the same manner as in Example 1, the negative electrode of Comparative Example 3 was subjected to the Safety test.

### Comparative Example 4

The negative electrode was produced in the same manner as Comparative Example 2 except for using SiO₂ (silica), which was unreactive with lithium and had an average particle diameter of 5 μm, instead of Al₂O₃. The configuration and the values obtained in the respective measurements are shown in Table 1.

The other steps as well as the production method of the positive electrode were carried out in the same manner as Example 1, to thereby produce the nonaqueous electrolyte secondary battery. In the same manner as in Example 1, the obtained nonaqueous electrolyte secondary battery was subjected to the measurements for the battery capacity and the capacity holding ratio.

In the same manner as in Example 1, the negative electrode of Comparative Example 4 was subjected to the SEM-EDX measurement.

In the same manner as in Example 1, the negative electrode of Comparative Example 4 was subjected to the measurement for the ratio of the thickness of the layer having the higher O ratio to the thickness of the negative electrode active material layer.

In the same manner as in Example 1, the negative electrode of Comparative Example 4 was subjected to the X-ray absorption spectroscopy measurement.

In the same manner as in Example 1, the negative electrode of Comparative Example 4 was subjected to the Safety test.

### Comparative Example 5

As the negative electrode active material, the mesophase pitch-based carbon fiber, which was subjected to the thermal treatment at 3,250° C. (the average fiber diameter was 10 μm, the average fiber length was 25 μm, the average plane spacing d(022) was 0.3355 nm, and a specific surface area based on the BET method was 3 m²/g), was used.

This negative electrode active material 95 mass % and the PVdF 5 mass % were added in NMP, followed by mixing those to thereby prepare the slurry.

This slurry was applied on the copper foil having a thickness of 12 μm (the electrode current collector) and then dried, to thereby form the coating film containing the aforementioned negative electrode active material.

Thereafter, the coating film was rolled, to thereby produce the negative electrode including the negative electrode active material layer. The configuration and the values obtained in the respective measurements are shown in Table 1.

The other steps as well as the production method of the positive electrode were carried out in the same manner as Example 1, to thereby produce the nonaqueous electrolyte secondary battery. In the same manner as in Example 1, the obtained nonaqueous electrolyte secondary battery was subjected to the measurements for the battery capacity and the capacity holding ratio.

In the same manner as in Example 1, the negative electrode of Comparative Example 5 was subjected to the Safety test.

TABLE 1

| | | Ratio of | | | |
|---|---|---|---|---|---|
| | | Thickness of | | | |
| | | 1st Layer to | | | |
| | | Thickness of | Ratio of O to | Ratio of O to | |
| | | Negative | Total Amount | Total Amount | Number of |
| | | Electrode | of Si, C and O | of Si, C and O | Absorption |
| | Configuration | Active | Contained in | Contained in | Peak at Si—K |
| | of Negative | Material Layer | 1st Layer | 2nd Layer | Absorption |
| | Electrode | (%) | (atom %) | (atom %) | Edge (number) |
| Example 1 | Si/SiO_{1.5} | 13 | 35 | 8 | 2 |
| Example 2 | Si/SiO_{1.5} | 5 | 35 | 8 | 2 |
| Example 3 | Si/SiO_{1.5} | 50 | 35 | 8 | 2 |
| Example 4 | Si/SiO_{1.5} | 38 | 35 | 8 | 2 |
| Example 5 | Si/SiO₂ | 10 | 50 | 14.8 | 2 |
| Example 6 | Si/SiO | 40 | 45 | 5 | 2 |
| Example 7 | Si/SiO_{1.2} | 24 | 20 | 12 | 2 |
| Example 8 | Si/SiO | 37 | 15 | 10 | 2 |
| Example 9 | Si/SiO_{1.8} | 30 | 36 | 7 | 2 |
| Example 10 | Si/SiO_{1.3} | 22 | 22 | 8 | 2 |
| Example 11 | Si/SiO₂ | 28 | 50 | 11 | 2 |
| Comparative | Si | — | — | 5 | 1 |
| Example 1 | | | | | |
| Comparative | Si/Al₂O₃ | 12 | 48 | 5 | 1 |
| Example 2 | | | | | |
| Comparative | Si/TiO₂ | 16 | 52 | 5 | 1 |
| Example 3 | | | | | |
| Comparative | Si/SiO₂ | 15 | 39 | 8 | 2 |
| Example 4 | (Unreactive | | | | |
| | with Lithium) | | | | |
| Comparative | Mesophase | — | — | — | — |
| Example 5 | Pitch-Based | | | | |
| | Carbon Fiber | | | | |

Table 2 shows the battery capacities and the capacity holding ratios of the nonaqueous electrolyte secondary batteries of Examples 1 to 11 and the nonaqueous electrolyte secondary batteries of Comparative Examples 1 to 5.

Herein, the battery capacity was described by setting the battery capacity of the nonaqueous electrolyte secondary battery of Comparative Example 5, which included the negative electrode formed of carbon, to be 1.

Also, Table 2 shows the results of the safety test (nail penetration test) of the nonaqueous electrolyte secondary batteries of Examples 1 to 11 and the nonaqueous electrolyte secondary batteries of Comparative Examples 1 to 5.

TABLE 2

| | Battery | | |
|---|---|---|---|
| | Capacity | 3 C Capacity | |
| | (Based on | Holding Ratio | Results of |
| | Comparative | (Based on | Nail Pene- |
| | Example 5) | 0.2 C Capacity) | tration Test |
| Example 1 | 1.53 | 0.84 | No Ignition |
| Example 2 | 1.66 | 0.89 | No Ignition |
| | | | (Gas Blowout) |
| Example 3 | 1.36 | 0.81 | No Ignition |
| Example 4 | 1.43 | 0.86 | No Ignition |
| Example 5 | 1.25 | 0.82 | No Ignition |
| Example 6 | 1.25 | 0.81 | No Ignition |
| Example 7 | 1.38 | 0.87 | No Ignition |
| Example 8 | 1.61 | 0.85 | No Ignition |
| | | | (Gas Blowout) |
| Example 9 | 1.48 | 0.88 | No Ignition |
| Example 10 | 1.42 | 0.84 | No Ignition |
| Example 11 | 1.10 | 0.80 | No Ignition |
| Comparative Example 1 | 1.82 | 0.92 | Ignition |
| Comparative Example 2 | 1.22 | 0.58 | No Ignition |
| Comparative Example 3 | 1.18 | 0.63 | No Ignition |
| Comparative Example 4 | 1.23 | 0.65 | No Ignition |
| Comparative Example 5 | 1 | 0.88 | Ignition |

As shown in Table 2, the battery capacities could be increased in the nonaqueous electrolyte secondary batteries of Examples 1-11 and Comparative Example 1 as compared to the nonaqueous electrolyte secondary battery of Comparative Example 5. By contrast, the battery capacities could not be increased in the nonaqueous electrolyte secondary batteries of Comparative Examples 2-4 as compared to the nonaqueous electrolyte secondary battery of Examples 1-11. It can be considered that this was because the oxides contained in the 1st layer (surface layer) did not contribute to the charge and discharge in the nonaqueous electrolyte secondary batteries of Comparative Examples 2-4.

Also, as shown in Table 2, the 3 C capacity holding ratios of the nonaqueous electrolyte secondary batteries of Comparative Examples 2-4 were lower than those of the nonaqueous electrolyte secondary batteries of Examples 1-11. It can be considered that this was because the oxides contained in the 1st layer (surface layer) did not contribute to the charge and discharge in the nonaqueous electrolyte secondary batteries of Comparative Examples 2-4, which caused the inhibition of the electrode reaction.

Also, as shown in Table 2, the ignition did not occur in the nonaqueous electrolyte secondary batteries of Examples 1-11 and Comparative Examples 2-4 although the gas blowout was observed in some. By contrast, the ignition eventually occurred in the nonaqueous electrolyte secondary batteries of Comparative Examples 1 and 5. It can be considered that this was because the short circuit prevention effect of the positive electrode and the negative electrode was exerted by the oxides contained in the 1st layer (surface layer) in the nonaqueous electrolyte secondary batteries of Examples 1-11 and Comparative Examples 2-4.

From the results described above, as in Examples 1 to 11, it could be confirmed that it was possible to increase the capacity of the nonaqueous electrolyte secondary battery and to improve the safety of the nonaqueous electrolyte secondary battery as long as the negative electrode active material layer constituting the negative electrode includes silicon capable of reacting with lithium, the negative electrode active material layer is formed by laminating the 1st layer containing SiO_{1.5} and the 2nd layer containing Si, and the 2nd layer is provided on the surface of the negative electrode current collector.

While certain embodiments have been described, these embodiments have been presented by way of example only, and are note intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A negative electrode for a nonaqueous electrolyte secondary battery comprising:
a negative electrode current collector; and
a negative electrode active material layer which includes a negative electrode active material and is formed on the negative electrode current collector, wherein
the negative electrode active material layer includes silicon capable of reacting with lithium,
the negative electrode active material layer includes a 1st layer containing an oxidized silicon compound and a 2nd layer containing the oxidized silicon compound,
the 2nd layer has the smaller amount of the oxidized silicon compound than the 1st layer, and
the 2nd layer is provided on the surface of the negative electrode current collector.

2. The negative electrode according to claim 1, wherein
the negative electrode active material layer contains at least three elements of carbon, oxygen and the silicon,
the ratio of the oxygen to the total amount of the three elements contained in the 1st layer is 15 atom % or more and 50 atom % or less, and
the ratio of the oxygen to the total amount of the three elements contained in the 2nd layer is 5 atom % or more and less than 15 atom %.

3. The negative electrode according to claim 1, wherein the ratio of the thickness of the 1st layer to the thickness of the negative electrode active material layer is 5% or more and 50% or less.

4. The negative electrode according to claim 1, wherein the oxidized silicon compound is SiOx (1≦x≦2).

5. The negative electrode according to claim 6, wherein the oxidized silicon compound is amorphous or in a state where Si and SiO₂ are disproportionated.

6. A nonaqueous electrolyte secondary battery comprising:
an exterior material;
a positive electrode that is housed in the exterior material;
a negative electrode that is spatially separated from the positive electrode and is housed in the exterior material with a separator interposed therebetween; and
a nonaqueous electrolyte charged in the exterior material, wherein
the negative electrode is the negative electrode according to claim 1.

7. The nonaqueous electrolyte secondary battery according to claim 4, wherein at least two absorption peaks at a Si K-edge in X-ray absorption spectroscopy during 1 V discharge are present within a range from 1835 eV to 1850 eV.

8. A battery pack comprising one or more of the nonaqueous electrolyte secondary battery according to claim 6.

9. The battery pack according to claim 8, wherein
a plurality of the nonaqueous electrolyte secondary battery are connected in series, in parallel or in a combination form of series connection and parallel connection, and
an electrifying terminal to an external device is mounted.
